(19) United States
(12) Patent Application Publication
(10) Pub. No.: US 2005/0161107 A1
(43) Pub. Date: Jul. 28, 2005

(54) Apparatus and method for loading concrete components in a mixing truck

(76) Inventors: Mark Turnbull, London (CA); Bob Dyment, Jerseyville (CA); Scott Rudy, Kitchener (CA)

Correspondence Address: John R.S. Orange;McCarthy Tetrault LLP, Suite 4700, P.O. Box 48, Toronto, ON, M5K 1E6, CA

(21) Appl. No.: 10/762,365

(22) Filed: Jan. 23, 2004

(51) Int. Cl. B67C 3/00

(52) U.S. Cl. 141/8

(57) ABSTRACT

The present invention is directed to an apparatus used for loading concrete components through a loading hopper of a mixing truck. It comprises a substantially vertically-disposed cement discharge pipe substantially centered within the discharge hopper. A water inlet is also provided in the discharge hopper. An aggregate feeding mechanism having an outlet above the discharge hopper allows providing aggregates to the mixture. This apparatus is less vulnerable to congestion since cement falls directly into the mixing truck and is encapsulated in the other concrete components. It also provides less and possibly no airborne dust particles because of encapsulation. Overall, the apparatus and the corresponding method provide an increase in flow and discharge of concrete components, thereby allowing faster loading of mixing trucks.

### FIELD OF THE INVENTION

The present invention relates to an apparatus and method for supplying components of a cementatious mixture to a mixing vessel.

### BACKGROUND

Cementatious materials, such as concrete, are made from the admixture of basic components, typically aggregate, cement and water, in a specified ratio. Whilst the components may be mixed manually, if the volume of concrete used is anything but nominal then a machine is used for mixing. Such machines will have a mixing vessel to receive the components and mix them together.

Because concrete is designed to solidify within a short period of time, it must be delivered within a few hours after being prepared and accordingly, its components cannot be mixed too much in advance. The admixture of the concrete components is achieved at a distribution facility. The distribution facility may be within a large engineering project but more usually is adjacent large urban areas to supply many locations within the immediate geographic area.

To facilitate the delivery of concrete from the distribution centre, mixing trucks have been developed. Mixing trucks are relatively large vehicles designed to carry pre-mixed semi-liquid concrete to a construction site or to any other location where concrete needs to be provided. They comprise a mixing vessel in the form of a large rotating drum in which the components of the concrete are deposited. To mix the components and inhibit separation of the components during transit, the drum is rotated as the truck travels to the site. The concrete components are brought together immediately before being delivered by the mixing trucks, which not only ensures that the maximum delivery time is available but also allows the adjustment of the composition of the concrete to fit the Individual needs of clients.

Typically, loading of a mixing truck at a distribution facility is achieved by positioning the mixing truck under an overhead structure. Components fall in a discharge hopper and are directed into an upper loading hopper of the mixing truck by gravity. This loading hopper communicates with the interior of the drum.

Cement is obviously a very important component of concrete. It is generally stored in a powdered form and only mixed with water in the vessel. One known problem with conventional charging apparatus Is that cement powder tends to agglomerate and block the discharge hopper. This situation requires that the congestion be removed by an operator or by a mechanism designed for that purpose. Congestion problems usually increase if the flow and discharge of components is increased. Reducing the flow of components may reduce the likelihood of congestions problems. However, this also increases the loading time of mixing vessel which is a particular problem when the vessel is mounted on a truck.

Against this background, it clearly appears that there is a need for an improved apparatus and an improved method for loading concrete components into a mixing vessel.

### SUMMARY

According to a first aspect of the present invention there is provided an apparatus for charging constituent components of concrete in to a mixing vessel. The apparatus comprises:
a discharge hopper having an outlet;
a substantially vertically-disposed cement discharge pipe substantially centered within the discharge hopper,
a water inlet in the discharge hopper, and
an aggregate feeding mechanism to supply aggregate to the discharge hopper.

According to another aspect of the present invention there is provided a method of charging constituent components of concrete through a loading hopper into a mixing vessel, the method comprising the steps of:
supplying water and aggregate to a discharge hopper having an outlet aligned with an inlet to a mixing vessel
discharging cement powder through a substantially vertically-disposed cement discharge pipe substantially centered within the discharge hopper whereby aggregates, water and cement are discharged from the outlet of the discharge hopper to the mixing vessel.

An embodiment of the invention will now be described by way of example only with reference to the accompanying drawings in which:

### BRIEF DESCRIPTION OF THE FIGURES

FIG. 1 is a schematic side view of a charging apparatus,

FIG. 2 is a schematic rear view of the apparatus shown in FIG. 1.

FIG. 3 is a schematic top plan view of the apparatus shown in FIG. 1.

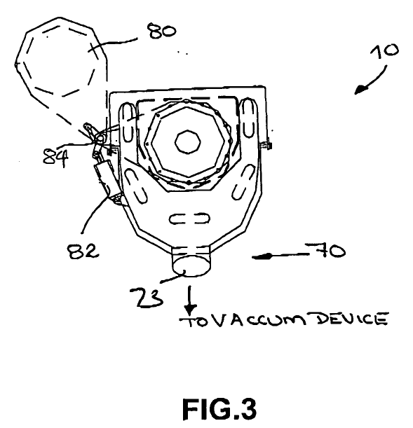

FIG. 4 is a view similar to FIG. 1, showing the apparatus in a retracted position.

FIG. 5 is a view similar to FIG. 2, showing the apparatus in a retracted position.

### DETAILED DESCRIPTION

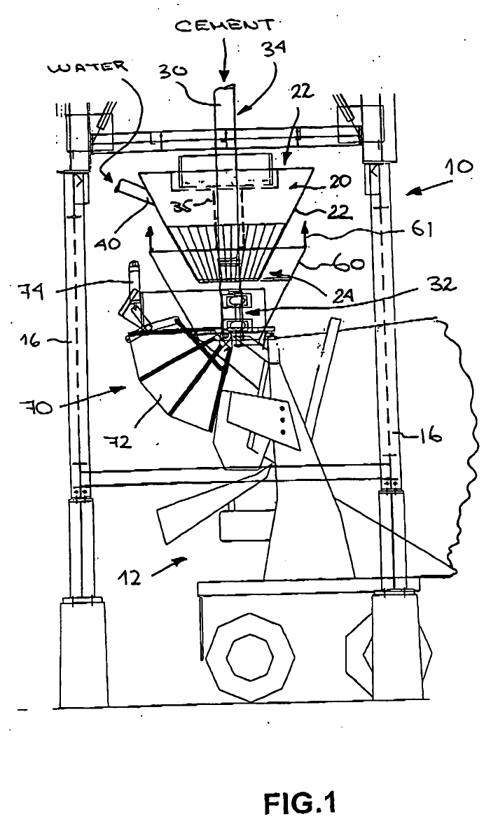

Referring therefore to FIG. 1, a charging apparatus (10) is used to load constituent components of concrete in a mixing truck (12) which is positioned under the apparatus (10) in a loading position. In the embodiment illustrated, the mixing truck (12) has a rear loading hopper (14) that communicates with the interior of a mixing vessel (15) rotatably mounted on the truck. It should be noted that some mixing trucks (12) have a loading hopper (14) located at the front. Furthermore, it should be noted that the expression “mixing truck” also covers any similar kinds of vehicles that are used to mix and carry semi-liquid concrete. One example would be a railroad car used on a very large construction site.

The apparatus (10) is supported in an elevated position on legs (16) so as to permit mixing trucks to drive directly under the apparatus (10).

The apparatus (10) comprises a discharge hopper (20) having an upper main section (22) and a bottom outlet (24). As shown, the discharge hopper (20) is frusto-conical to taper progressively inward toward the outlet 24. Different shapes may of course be used. The discharge hopper (20) is designed so that components therein will fall by gravity through the outlet (24) and then into the loading hopper (14). Interior surfaces of the hopper 20 are covered with wear resistant linings that can readily be replaced.

The apparatus (10) is further provided with a substantially vertically-disposed cement discharge pipe (30). This pipe (30) is connected to a cement powder delivering system (not shown) that controls flow through the pipe 30. The pipe (30) is substantially centered within the discharge hopper (20). As explained hereafter, this configuration was found to provide many advantages.

The bottom end of the pipe (30) comprises a flexible bottom end section (32) downwardly projecting into the outlet (24) of the discharge hopper (20). This flexible end section (32) is formed from rubber hose or a similar material. The pipe (30) also includes an upper rigid section (34), which section (34) is preferably made of steel since it is subjected to intense abrasion and stresses during the operation of the apparatus (10). At least a portion of the upper steel section (34) is covered by a removable wear liner 35, for example, in the form of a sleeve. The sleeve can then be replaced when worn.

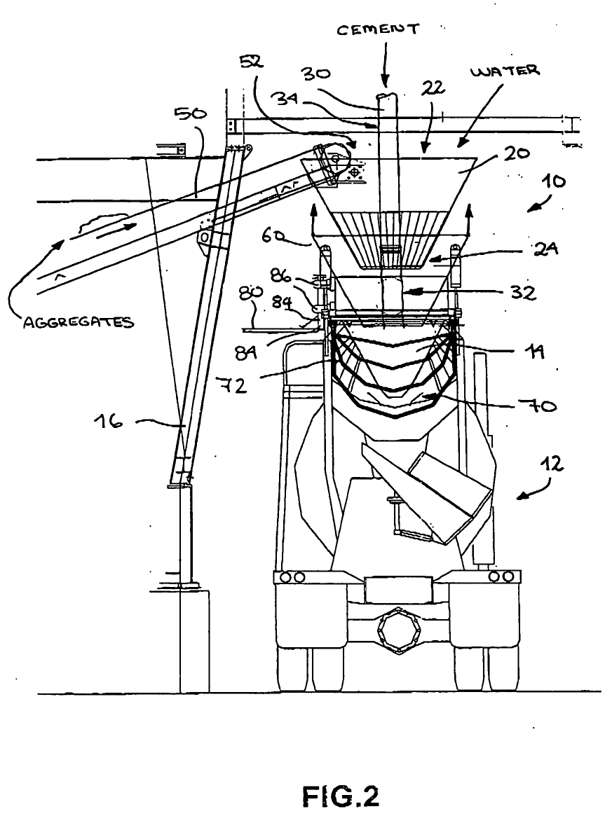

A water inlet (40) is provided In the discharge hopper (20). Water is provided using an appropriate supply system (not shown) and can be combined with various additives, depending on the desired characteristics of the concrete. The water inlet (40) is oriented to create a swirling motion that will promote mixing of the concrete components inside the discharge hopper (20). One of these components is a mixture of aggregates, such as sand, gravel, etc. These aggregates are brought into the discharge hopper (20) by an aggregate feeding conveyor (50) having an outlet above the discharge hopper (20). In the illustrated embodiment, the aggregate feeding mechanism (50) comprises a conveyor belt that is positioned and disposed so that, at its outlet (52), the aggregates fall directly into the discharge hopper (20), as best shown in FIG. 2.

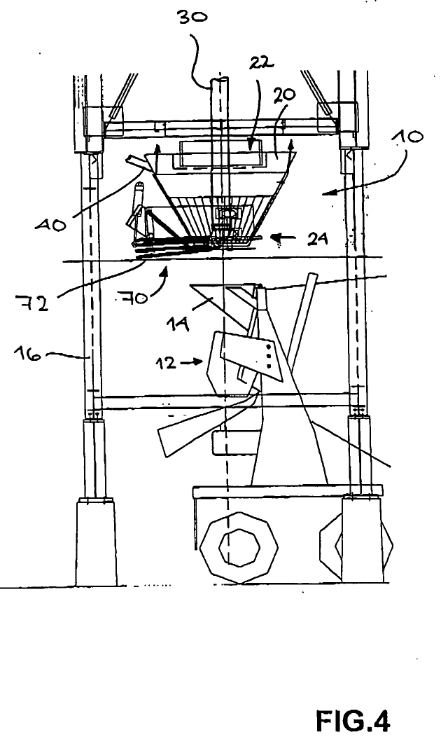

In order to accommodate different configurations of truck, a vertically movable funnel-shaped hood (60) is provided about the outlet (24) of the discharge hopper (20). The hood (60) can be made of a rigid material, such as, for example, steel or another rigid metal. Its shape corresponds to that of the hopper 20 so as to be nestable with the hopper. The hood (60) is vertically movable between a retracted position shown in FIG. 4 and a loading position shown in FIG. 2. A hoist system 61 or another lifting system is used to move the hood (60) up and down as indicated by arrows in the figures. Alternatively, one can provide a hoist system to move the entire apparatus (10). Safety equipment, such as chains, are advantageously provided at various locations to support the apparatus (10) or its hood (60) in case of a failure of the hoist system.

The apparatus (10) further comprises a dust collector (70) to collect airborne dust particles coming out of the discharge hopper (20) and loading hopper (14) during loading. The dust collector (70) has a retractable dust hood (72) operatively connected to an actuator (74). The dust hood (70) is used to enclose a space in fluid communication with a vacuum device (73) forming part of a dust collection system.

A plate (80) extends horizontally and is selectively movable between a first position where the plate (80) is located under the outlet (24) of the discharge hopper (20), and a second position where the plate (80) is away from the outlet (24) of the discharge hopper (20). The plate (80) is supported on an axle (84) and a set of bearings (86) for rotation about a vertical axis. The axle is mechanically connected through a linkage to an actuator (82) that is operable to rotate the axle and move the plate 80 sideways in the horizontal plane. In the first position the plate (80) is located beneath the outlet 24 and prevents any remaining components in the loading hopper (20) from falling onto a mixing truck (12) travelling under the apparatus (10).

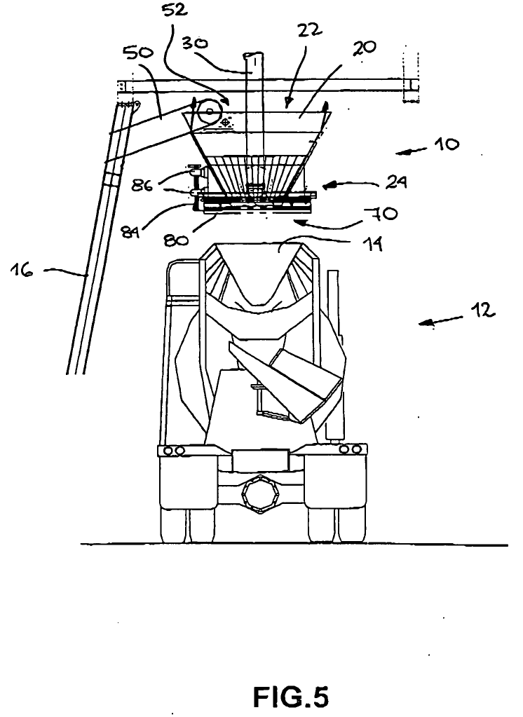

In use, the truck 12 is positioned with the outlet (24) of the discharge hopper (20) aligned with the loading hopper (14) of the mixing truck (12). As seen in FIGS. 4 and 5, the hood (60) and the dust hood (72) are retracted so that the mixing truck (12) can travel under the apparatus (10). The plate 80 is in the first position across the outlet 24 and also engages the flexible lower bottom end section 32 of the pipe 30 to elevate it and enable the truck to pass under the pipe. The hood 60 is then lowered and the dust hood 72 deployed. The actuator 84 slides the plate 80 away from the outlet 24 and charging of the mixing vessel can then be initiated.

Aggregates, water and cement are fed into the discharge hopper (20) through their respective feeds. The cement is provided through the vertical pipe 30 where clogging is minimized and aggregate supplied from the conveyor 50 into the hopper 20. The water is supplied through the water outlet 40 to flush the aggregate through the hopper 20. The components may be fed simultaneously into the hopper 20 and through hood 60 to the mixing vessel. However, it has been found that initiating the feeding of the aggregates and water a short time before initiating the feeding of the cement allows the encapsulation of the cement powder and generates less dust particles.

When the required components have been fed in to the mixing vessel the flow is terminated and the plate again moved to close the outlet 24. The hood 60 is then raised to deflect the flexible pipe 32 and the truck may depart.

As may be appreciated, the apparatus (10) is less vulnerable to congestion since cement falls directly into the mixing truck (12) and is encapsulated in the other concrete components. The encapsulation also reduces the airborne dust particles Overall, the apparatus (10) and the corresponding method have been found to provide an increase flow and discharge of concrete components, thereby allowing faster loading of mixing trucks.

1. An apparatus for charging constituent components of concrete into a mixing vessel, the apparatus comprising:
a discharge hopper having an outlet;
a substantially vertically-disposed cement discharge pipe substantially centered within the discharge hopper;
a water inlet in the discharge hopper; and
an aggregate feeding mechanism having an outlet above the discharge hopper.

2. The apparatus according to claim 1, wherein the cement discharge pipe comprises an upper rigid section and a flexible bottom end section, the bottom end section downwardly projecting into the outlet of the discharge hopper.

3. The apparatus according to claim 2, wherein the upper rigid section of the cement discharge pipe is made of steel.

4. The apparatus according to claim 3, wherein at least a portion of the upper steel section is covered by a removable wear liner.

5. The apparatus according to claim 1, wherein the discharge hopper comprises at least one removable wear liner.

6. The apparatus according to claim 1, wherein the water inlet is located in the main section of the discharge hopper.

7. The apparatus according to claim 1, wherein the aggregate feeding mechanism comprises a conveyor belt.

8. The apparatus according to claim 1, further comprising means for vertically moving the outlet of the discharge hopper with reference to the loading hopper of the mixing truck.

9. The apparatus according to claim 8, wherein the outlet of the discharge hopper comprises a vertically movable funnel-shaped hood.

10. The apparatus according to claim 8, wherein the hood is made of a rigid material.

11. The apparatus according to claim 1, further comprising a dust collector to collect airborne dust particles coming out of the outlet of the discharge hopper and the loading hopper.

12. The apparatus according to claim 1, wherein the dust collector comprises a retractable dust hood operatively connected to an actuator.

13. The apparatus according to claim 12, wherein the dust hood encloses a space in fluid communication with a vacuum device.

14. The apparatus according to claim 1, further comprising a substantially horizontally-disposed plate selectively movable between a first position where the plate is located under the outlet of the discharge hopper, and a second position where the plate is away from the outlet of the discharge hopper.

15. The apparatus according to claim 14, wherein the plate is mechanically connected to an actuator.

16. The apparatus according to claim 15, wherein the plate is movable sideways.

17. A method of charging constituent components of concrete through a loading hopper into a mixing vessel, the method comprising the steps of:
supplying water and aggregate to a discharge hopper having an outlet aligned with an inlet to a mixing vessel
discharging cement powder through a substantially vertically-disposed cement discharge pipe substantially centered within the discharge hopper whereby aggregates, water and cement are discharged from the outlet of the discharge hopper to the mixing vessel.

18. The method according to claim 17, further comprising:
initiating the feeding of the aggregates and water of the cement.

19. The method according to claim 17, further comprising:
lowering the outlet of the discharge hopper when it is aligned with the loading hopper of the mixing truck.

20. The method according to claim 17 further comprising:
covering the outlet of the discharge hopper and the loading hopper for collecting airborne dust particles when feeding aggregates, water and cement into the discharge hopper.

21. The method according to claim 17, further comprising:
moving a substantially horizontally-disposed plate under the outlet of the discharge hopper for protecting a mixing truck traveling under the discharge hopper.
